(19) United States
(12) Patent Application Publication
(10) Pub. No.: US 2017/0011038 A1
(43) Pub. Date: Jan. 12, 2017

(54) SYSTEM AND METHOD FOR MULTIPLE FACTOR SORTING AND USER INTERFACE THEREOF

(71) Applicant: David Revelle, Ann Arbor, MI (US)

(72) Inventor: David Revelle, Ann Arbor, MI (US)

(21) Appl. No.: 14/792,302

(22) Filed: Jul. 6, 2015

(51) Int. Cl. G06F 17/30; G06F 3/0484

(52) U.S. Cl. CPC G06F 17/3053; G06F 17/30867; G06F 3/04847

(57) ABSTRACT

A system and method for multiple factor sorting and a user interface thereof are described. The system allows a user to quickly articulate and convey to a computing system, through the use of multiple variably-weighted factors, the nuance of the user's thought process as it relates to retrieving information or making a decision. When a person retrieves information and desires to sort into an order a plurality of items and where the user desires to sort the order of items based on a multiplicity of factors, the system provides a graphical, modifiable representation of the factors that enables the user to temporarily interrelate and variably prioritize those factors by applying input to modify the graphical representation of the factors such that as the user increasingly prioritizes one factor, the remaining factor(s) are proportionately decreased in priority, such change(s) of prioritizations subsequently resulting in a reordering of the items to reflect the change(s).

### FIELD

The disclosure relates to computing systems and a user's ability to quickly articulate and convey to a computing system, through the use of multiple variably-weighted factors, the nuance of the user's thought process as it relates to retrieving information or making a decision.

### BACKGROUND

The complexity of the human mind is well established, and humans' capacity to concurrently consider multiple factors in the context of a search for information is obvious. The multiple factors considered by a person in any given instance of searching or decision-making are not necessarily inherently related to one another, and are often otherwise unrelated, but they become temporarily interrelated in the context of the instance as the person consciously or unconsciously weighs the factors against one another. For example, a person selecting a meal from a restaurant menu may concurrently take into account multiple independent factors including which food items appeal the most to him at that time, pricing, nutritional value, the level of his perceived hunger, and other factors, and the person weighs and prioritizes these multiple factors in temporary interrelationships to one another in choosing his meal in that instance.

The multiple factors that a person considers in any given instance become temporarily interrelated, but they also share during the instance, a fixed total value of prioritization that may be variably allocated to the individual factors. If the fixed value of prioritization is arbitrarily defined as 100 points, and in a given instance a person considers four factors, the 100 points may be distributed variably amongst the four factors, but the total number of points assigned to all four factors in any moment of distribution must always remain 100. Most persons understand this phenomenon as a result of daily life in that as certain things become more important to them, other things necessarily recede in importance.

As a present day example of existing art, a consumer uses her computer to search for a hotel in Chicago on a travel agency website such as Expedia.com, and the search results are returned to the consumer as a list containing more than 600 hotels. Presently, Expedia.com and its competitors offer to the consumer two general methods of influencing the ordering of the search results list, subtractive filters and single-factor sorting.

If the consumer cares only about a single factor, such as price, or star rating, or guest reviews, revising the order in which the hotels appear is easily accomplished, as such websites typically provide the consumer with the ability to re-sort the order of search results based on a single factor. However, in many cases, the selection of a hotel involves more than a single factor making this type of sorting ineffective. In addition to single-factor sorting, travel agency websites usually provide subtractive filters that, when selectively applied by the consumer, will eliminate some hotels from the list to reduce the number of choices for the consumer. However, while the application of filters shortens the list of hotels, and single-factor sorting then reorders that abbreviated list, the hotels at the top of the list are still not necessarily the ones best suited to the user.

### BRIEF DESCRIPTION OF THE DRAWINGS

FIG. 1 illustrates a multiple inter-related factor component that is part of a search website system;

FIG. 2 illustrates a multiple inter-related factor system that provides multiple inter-related factor results to a third party;

FIGS. 3A and 3B illustrate examples of a search query user interface of a typical search system;

FIG. 4 illustrates another example of a search query user interface of a typical search system;

FIG. 5 illustrates a method for generating multiple inter-related factor search results;

FIG. 6 illustrates an example of a slider user interface for entering multiple inter-related factors;

FIG. 7 illustrates an example of a chart user interface for entering multiple inter-related factors;

FIG. 8 illustrates an example of a pie chart user interface for entering multiple inter-related factors;

FIG. 9 illustrates an example of another user interface for entering multiple inter-related factors; and

FIG. 10 illustrates a search results user interface including the results of the multiple inter-related factors.

### DETAILED DESCRIPTION OF ONE OR MORE EMBODIMENTS

The disclosure is particularly applicable to a search system that incorporates a multiple inter-related factor component model or a software as a service model and it is in this context that the disclosure will be described. It will be appreciated, however, that the system and method has greater utility since it may be implemented in different manners than those disclosed below that would be within the scope of the disclosure.

The system permits a user to quickly and articulately convey to a computing system the nuance of the user's thought process as it relates to retrieving information or making a decision using multiple variably-weighted, inter-related factors. Where a person retrieves information and desires to sort into an order a plurality of items, and where the user desires to sort the order of items based on a multiplicity of factors, a graphical, modifiable representation of the factors is established that enables the user to temporarily interrelate and variably prioritize those factors by applying input to modify the graphical representation of the factors such that as the user increasingly prioritizes one factor, the remaining factor(s) are proportionately decreased in priority, such change(s) of prioritizations subsequently resulting in a reordering of the items to reflect the change(s).

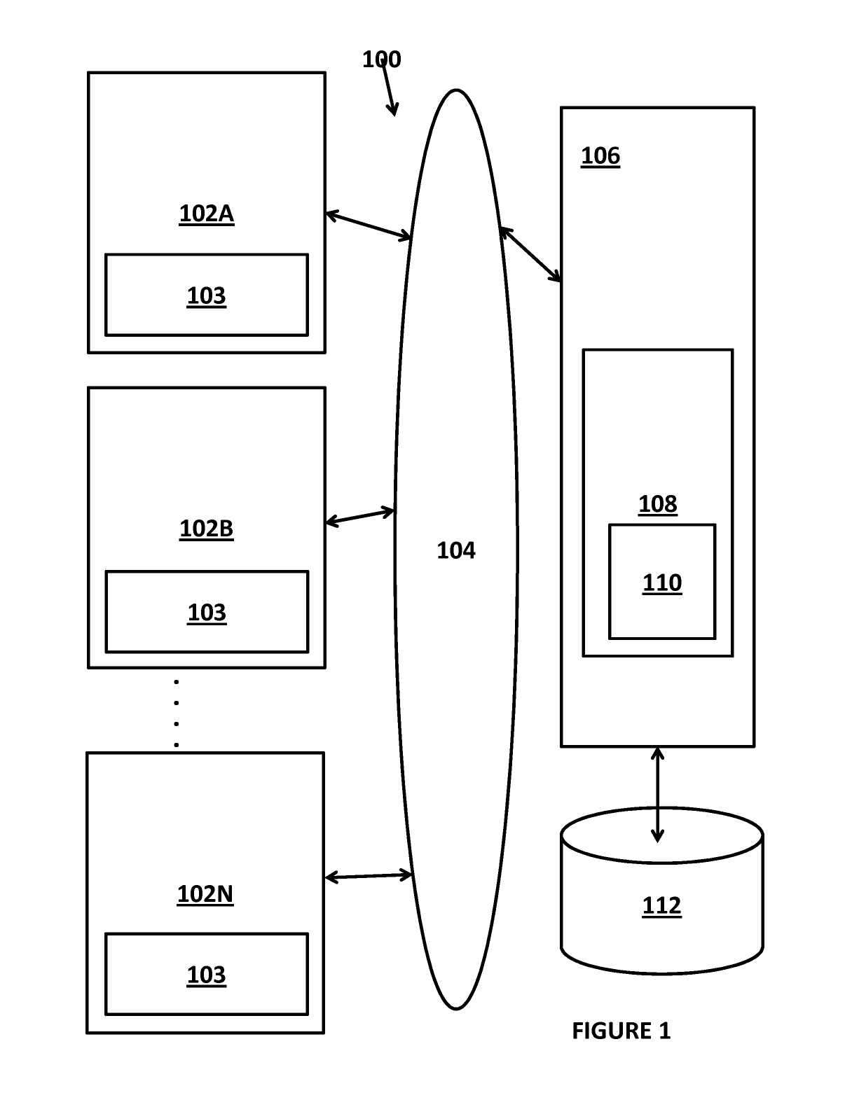

FIG. 1 illustrates a multiple inter-related factor component 110 that is part of a search website system 100. The search system 100 may have one or more computing devices 102, such as computing device 102A, 102B, . . . , 102N, that interface with a search backend system 106 over a communications path 104 to generate and submit search queries and receive search results from the search system 100 based on the query. Each computing device 102 may be a processor based device that has one or more processors, memory, a display, persistent memory, such as flash memory or a hard disk drive and communications circuits that allow the computing device connect to over the communications path 104 with the backend system 106. For example, each computing device 102 may be a smartphone device, such as an Apple® iPhone® or Android® operating system based device, a desktop computer, a laptop computer, a tablet computer, a terminal device and the like. In some embodiments, each computing device 102 may store and execute (or download and then execute) a browser application 103 that is executed by the processor of the computing device and manages the connection to and data exchange with the backend system 106. In the system, each computing device may generate its own search query (from user input) that is responded to by the backend system 106 and then receive search results back from the backend system that may be displayed on the display of the computing device to the user.

The communications path 104 may be a wireless or wired communications path or a combination of both a wireless and wired communications paths. For example, the communications path 104 may be a Wifi network, a digital data network, a cellular digital data network, a cellular network, a computer network, the Internet, Ethernet and the like. The communications path 104 may use any protocols, such as HTTP or HTTP. In the embodiment in which browser applications are being used, the communications path 104 may carry HTML data that is being exchanged between each computing device 102 and the backend system 106.

The backend system 106 may be a computer system that has one or more computing resources. For example, the computing resources may be a server computer, an application server, a database server, a blade server, a processor, memory, persistent storage or communications circuits or cloud computing resources. The backend system 106 may further include a search engine 108 that may be hosted on the backend system's computers that may receive a search query and return results to each search query. The backend system 106 may further comprise a multiple inter-related factor component 110 that receives multiple inter-related factor inputs and generates an updated search results using the multiple inter-related factor inputs. The backend system 106 may further comprise a store 112 that may store various information used by the system including a search index and other information used by system.

Each of the search engine 108 and the multiple inter-related factor component 110 may be implemented in hardware or software. When the search engine 108 or the multiple inter-related factor component 110 is implemented in software, the search engine 108 or the multiple inter-related factor component 110 may include a plurality of lines of computer code that may be executed by one or more processors of the backend system 106 so that the processors are configured to perform the functions and operations of the search engine 108 or the multiple inter-related factor component 110 as described below. When the search engine 108 or the multiple inter-related factor component 110 is implemented in hardware, the search engine 108 or the multiple inter-related factor component 110 may be an integrated circuit, an application specific integrated circuit, a state machine, a microcontroller and the like that perform the functions and operations of the search engine 108 or the multiple inter-related factor component 110 as described below.

The multiple inter-related factor component 110 may receive the initial search query results, generate a user interface to receive multiple inter-related factor (such as by a user of the computing device inputting the factors into the computing device using an input device like a keyboard or virtual keyboard or mouse) and then generate a multiple inter-related factor user interface search results data that may be displayed to the user to allow the user to review the search results. As the screen size of computing devices continues to shrink, the importance increases of being able to easily and variably select and apply multiple factors and prioritize them in an interrelated way to improve how results are sorted as is done using the multiple inter-related factor component 110.

In one embodiment of the multiple inter-related factor component 110, the user selects two or more factors that are relevant to the current search query. In one embodiment, the one or more factors may be the search terms of the user's search query. For example, if the user enters search term(s) into a Google search engine, the multiple inter-related factor component 110 generates an interactive user interface/graphic element, such as a slider, for each search term labaled with each search term so that the user may then assign inter-related weights or importances to the terms that are conveyed to and inform the search engine thereby enabling it to re-sort the search results more appropriately for the user.

In another embodiment in which the system may be used with a more specialized search engine, such as that of an online travel agency or an online dating site, for example, much or all of the data associated with the specialized search engine may be categorized into specific fields so that the multiple inter-related factor component 110 may generate a list of those data fields and the user may select the two or more factors from the list of the data fields. Thus, for a dating search engine, the possible factors that may be selected by the user may be “height”, “eye color” and the like. As another example, a travel metasearch engine may provide a list of search terms that are specifically relevant to the data it maintains, and the list for hotels may include terms that describe each hotel property, such as “indoor pool”, “free parking”, “spa”, but may also include other terms such as the “walkability” score of the hotel's location, averaged “guest reviews” score, and the like.

Upon selection of each factor, the user may be provided with the opportunity for further input to further define or add attributes to that factor. For example, certain factors, such as target price and location for a travel search engine, need to be defined or further described by the user. For example, if “location” is the factor selected by the user the user needs to further define the location, such as Dallas, Tex., the Dallas Convention Center or a specific street address in Dallas. After the user has selected and defined multiple factors, a graphical representation of the multiple factors appears. This graphical representation is modifiable by user input (for example, by using a fingertip or stylus on a touchscreen, or by using a mouse-controlled cursor) such that when the graphical representation of one factor is modified to represent that a particular factor shall be allocated more or less priority, the remaining factors and their graphical representations automatically adjust accordingly and in proportion to the modified factor and to each other. These factors that are related to each other as described above are the multiple inter-related factors. Thus, the change in one factor effects the other factors.

The multiple inter-related factors are inter-related in that when the priority or importance of one factor is increased, the priority or importance of the other factors are proportionally decreased so that the total priority or importance of all of the factors stays constant. For example, if there are two factors which each has a 50% priority or importance and the user adjusts a first factor to 70% priority or importance, the other factor would be reduced to 30% so that the total priority or importance of all of the factors stays constant. In an example in which there are more than two factors, a change in one factor in a first direction (more priority, for example) results in changes of the other factors in an opposite direction (lower priority in the example.) The priority or importance of each factor may also be a weighting for each factor and the sum of the weighting of all of the factors is a constant value, such as 1 or 100%. In addition, regardless of the number of factors that may be selected, the typical default starting point of the priority/importance for each factor is the mid-point representing that until the user communicates otherwise, all factors are to be given equal weight. However, a default starting point for each factor that is not the midpoint may be preferred in some embodiments.

The multiple inter-related factors also permits that when one factor is changed, the resulting changes in the other factors may be equal or unequal. For example, in one embodiment, if the user has selected or inputted five factors and the user increases one factor by twenty units, the other four factors may be each decreased equally by five units. In other embodiments, the other factors may be decreased in proportion to each factor's position relative to the other factors so that the lowest priority/importance factor would be decreased the least. In other embodiments, the other factors may be decreased in proportion to their positions relative to a mid-point (the closer to the mid-point that a factor is, the greater the change of that factor) or other variations.

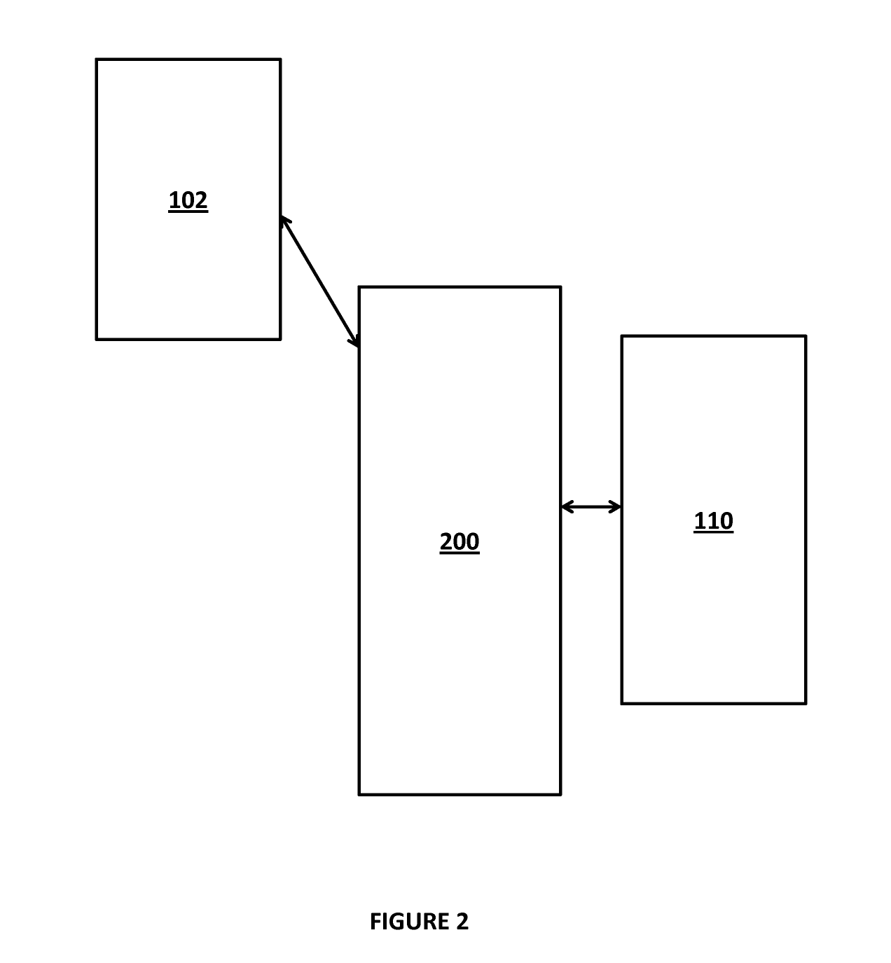

FIG. 2 illustrates a multiple inter-related factor system that provides multiple inter-related factor results to a third party. In this system, the computing devices 102 may interface and interact with a third party search system 200 as described above. In this exemplary implementation, the multiple inter-related factor component 110 may be a standalone system that provides the multiple inter-related factor functionality to the third party search system 200. In this implementation, the multiple inter-related factor component 110 may be implemented in hardware or software as described above.

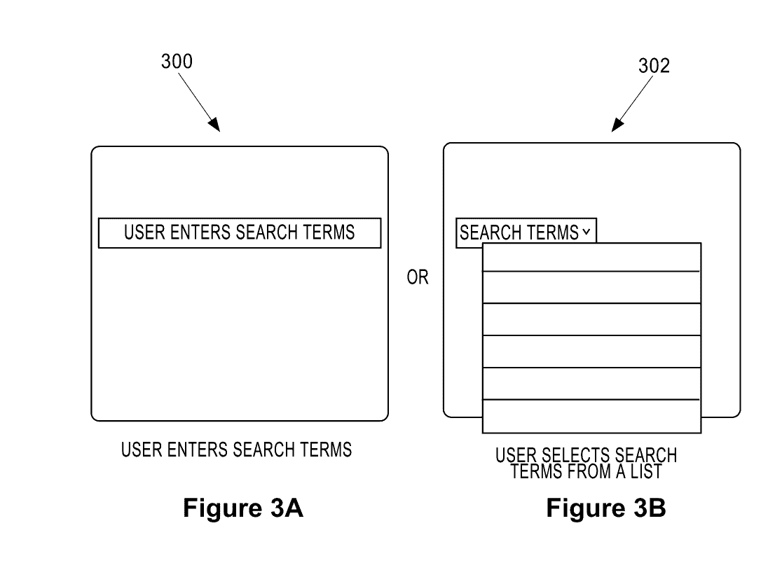

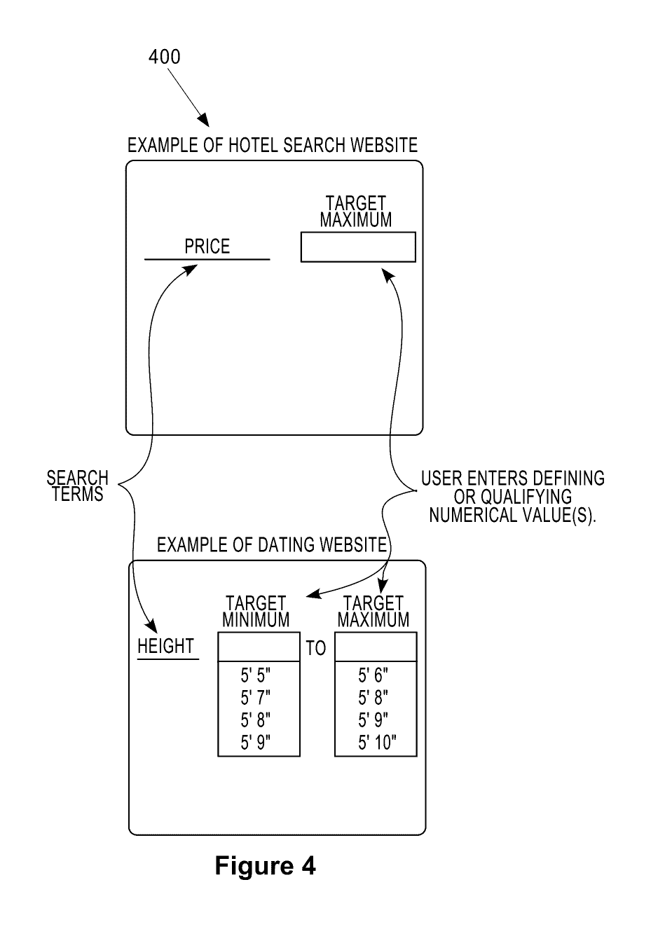

FIGS. 3A and 3B illustrate examples of a search query user interface of a typical search system in which the user may input search terms into an input box of a search user interface (FIG. 3A) or may select search terms from a list as shown in FIG. 3B. Furthermore, FIG. 4 illustrates another example of a search query user interface of a typical search system in which the user may enter defining or qualifying numerical or text value(s) for a particular search term. In the example in FIG. 4, a price search term for a hotel search website in which the user may enter a value for the price and a height search term for a dating web site in which the user may enter a value for the height are shown.

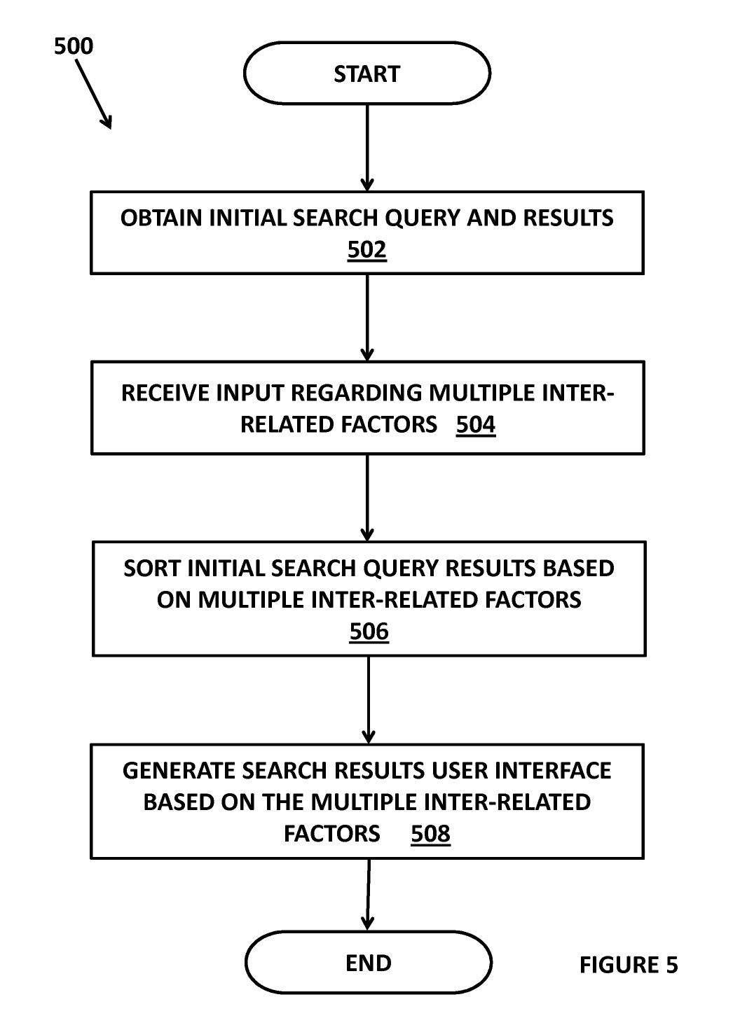

FIG. 5 illustrates a method 500 for generating multiple inter-related factor search results. The method may be performed, for example, by the multiple inter-related factor component 110 shown in FIGS. 1 and 2. In the method, an initial search query and initial search results may be obtained (502) from the search engine. In the method, input regarding multiple inter-related factors may be received (504). During this process, one or more factors may be selected and then may be adjusted relative to each other as described below. In one embodiment, a user may select the one or more factors and then use a graphical user interface to adjust the factors' significance relative to each other. Thus, a change in a factor effects the other factors.

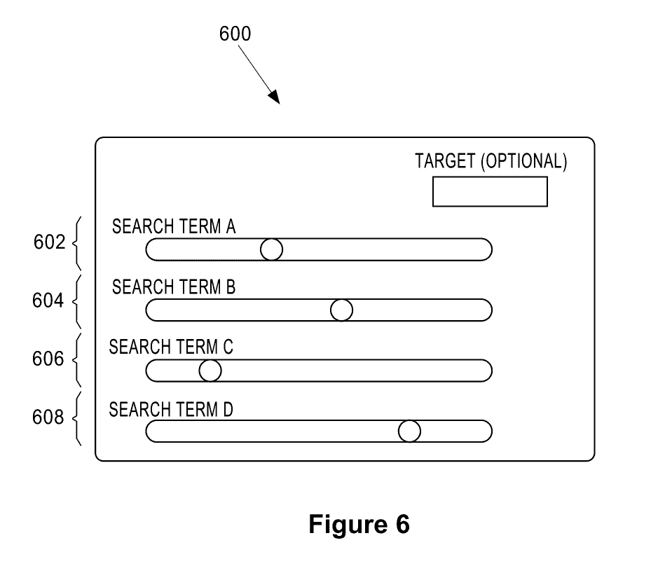

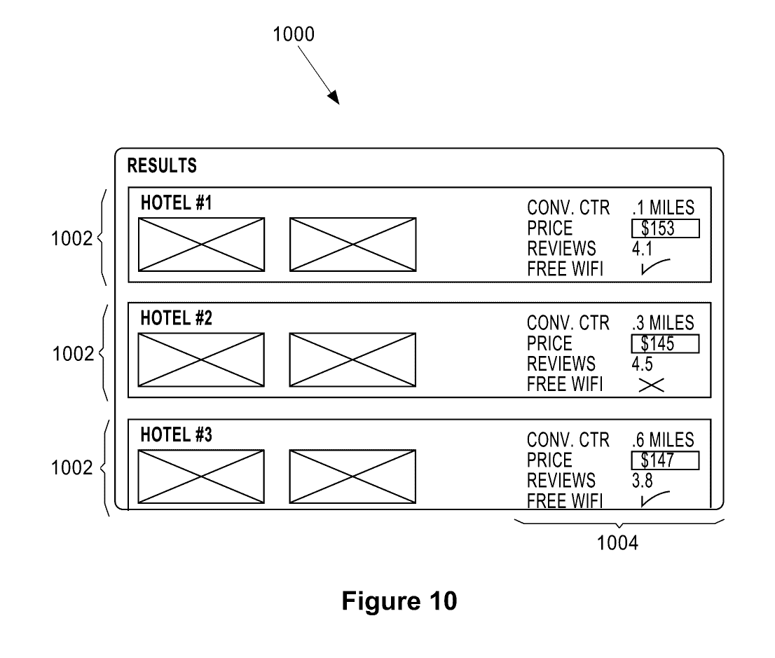

Once the one or more adjustments to the factors are received, the method may resort the initial query search results based on the multiple inter-related factors (506). The method may then generate a search results user interface based on the multiple inter-related factors (508). An example of that user interface is shown in FIG. 10. However, various different user interfaces that may be used to adjust the multiple inter-related factors (described below with reference to FIGS. 6-9) and display the search results user interface based on the multiple inter-related factors and it should be understood that other user interfaces (not shown) to adjust the multiple inter-related factors and display the search results user interface based on the multiple inter-related factors are within the scope of the disclosure and the disclosure is not limited to any particular graphical user interface. For example, a user interface is contemplated that would combine the multiple inter-related factors user interface and the search results user interface such that the user may adjust the multiple inter-related factors and simultaneously view the search results as they re-sort in response to the new weightings. Another contemplated embodiment places the multiple inter-related factors user interface within each search result.

FIG. 6 illustrates an example of a slider user interface 600 for entering multiple inter-related factors. In the user interface in FIG. 6, each factor is graphically represented by a slider 602-608 that allows a user to adjust the relative importance/priority of each factor. For example, priority may be increased by sliding to a particular slider to the right and decreased by sliding to the left. For example, as shown in FIG. 6, search term/factor B has a higher priority than search term/factor A or search term/factor C. Since the factors are always inter-related in a given instance, the sliders 602-608 that represent the factors may be linked so that as one slider is adjusted by the user (to adjust the priority of a particular factor), the other sliders and the priorities of the other factors that they represent are conversely affected thereby representing the interrelationship of the factors.

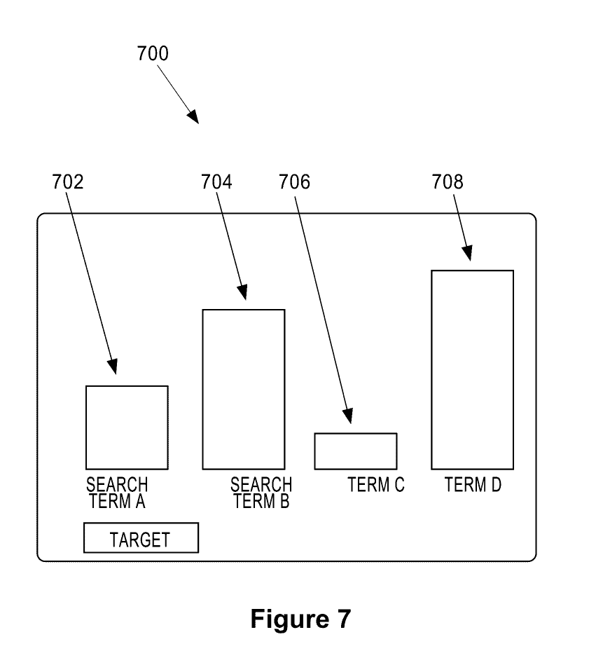

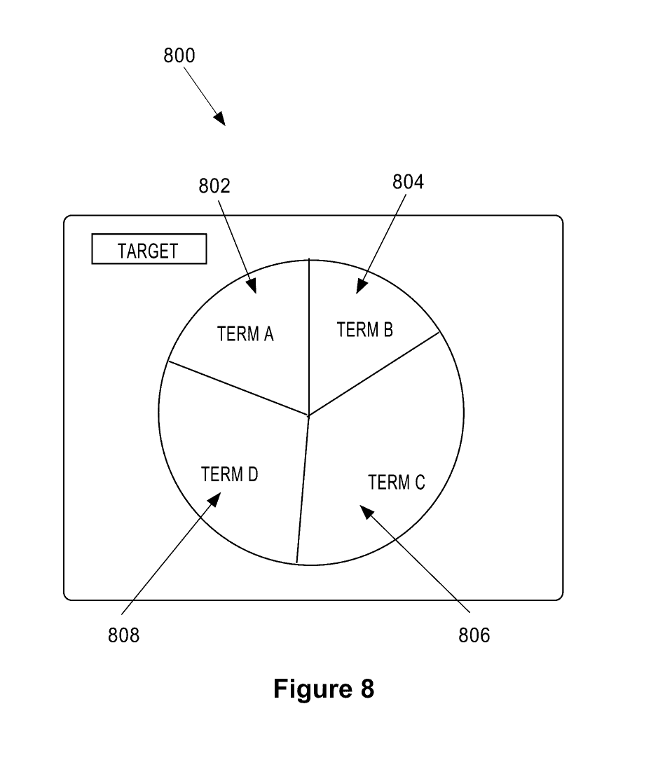

FIG. 7 illustrates an example of a chart user interface 700 for entering and adjusting the priorities of the multiple inter-related factors in which a bar 702-708 may represent each factor and the height of each bar represents the current priority of that factor. In this user interface, the user can adjust the bar heights to adjust the priorities of the factors which are again inter-related as described above. FIG. 8 illustrates an example of a pie chart user interface 800 for entering and adjusting the priorities of the multiple inter-related factors in which a pie section 802-808 may represent each factor and the size of each piece represents the current priority of that factor. In some embodiments, the different pie section may have different colors. Since the factors are inter-related, as the user drags the border between two sections in a particular direction to increase or decrease the size of a section, the other borders move in concert.

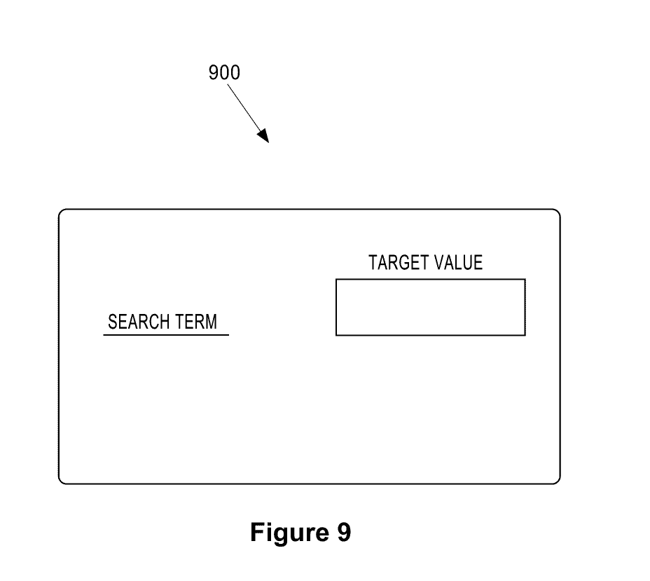

FIG. 9 illustrates an example of another user interface for entering multiple inter-related factors in which the user can enter a search term and a target value. Existing systems provide filtering or searching by numerical values, but the numerical values are absolute limits (e.g., search for a hotel with a maximum price of $150.) The system and method described above permits a user to assign a target value (as shown in FIG. 9) in the context of the multiple inter-related, variably weighted factors/terms. The target value assigned by the user allows the multiple inter-related factor component 110 to override an absolute limit in the context of other search terms and their respective weights that may be specified by a user. For example, if a user searches for a hotel using four search factors, location (120 Main St.), target price ($100), free breakfast, and a swimming pool, and if the user prioritizes location above the other factors, a hotel that is located next door at 130 Main St. and which offers a pool and free breakfast could be at the top of the search results even if its actual price is $108, or somewhat above the target price. The enabling of such an override allows the search results to more accurately reflect the nuances of human thinking and decision-making, because in the example just described, most users would probably decide to pay slighty more than their target price for a hotel that is otherwise the best match based on the chosen factors and their user-assigned weightings.

FIG. 10 illustrates a search results user interface 100 including the results of the multiple inter-related factors. As shown, the search results user interface has one or more search results 1002 with each search result having a factor portion 1004 that displays how each search result/listing matches up with the multiple inter-related factors/terms by showing the term/factor and any defining and qualifying information. In the example, the most heavily weighted search term/factor was location (in the case of a search for hotels near a convention center) and the results show the location as the first term/factor along with a distance from the hotel to the searched location. It is understood that the defining/qualifying information, such as the distance for the location factor/term, will be different for each term/factor. In the example in FIG. 10, a price term/factor was weighted second and the price of $153 for a particular room is highlighted to warn the user that the price for the particular room was above the user's specified target price. Some terms/factors information may be represented as a Yes or No or a check mark or X as appropriate.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method, comprising:
obtaining two or more inter-related factors;
sorting results using the two or more inter-related factors into a multiple factor sorted set of results, wherein when one factor has its weight changed in a first direction, the other inter-related factors have their weight changed in a second opposite direction so that a total weighting of all of the inter-related factors is constant; and
generating a multiple factor sorted set of results, the multiple factor sorted set of results listing each search result.

2. The method of claim 1 further comprising receiving an initial query that generates the plurality of results, the initial query having two or more search terms.

3. The method of claim 1, wherein sorting the plurality of results further comprises receiving a weighting for each factor using a user interface.

4. The method of claim 3, wherein the user interface is a graphical representation that displays the multiple factors.

5. The method of claim 4, wherein the user interface is a set of sliders.

6. The method of claim 4, wherein the user interface is a chart.

7. The method of claim 4, wherein the user interface is a pie chart.

8. The method of claim 1 further comprising displaying the multiple factor sorted set of results.

9. The method of claim 8 further comprising concurrently displaying the user interface and the multiple factor sorted set of results.

10. The method of claim 8 further comprising displaying the user interface one of concurrently with and embedded within each search result.

11. The method of claim 8, wherein the multiple inter-related factors further comprises a target value factor.

12. The method of claim 11, wherein displaying the multiple factor sorted set of results further comprises displaying an indication that a value for a particular factor has exceeded the target value.

13. The method of claim 2, wherein each factor is one of the search terms from the initial query.

14. The method of claim 1, wherein sorting the plurality of results from the initial search using two or more inter-related factors further comprises selecting the two or more inter-related factors from a list and receiving a weighting for each selected factor.

15. The method of claim 3, wherein receiving the weighting of each factor further comprises adjusting the weighting of at least one factor in a first direction and effecting the weightings of the other factors in an opposite direction.

16. The method of claim 15, wherein effecting the weightings of the other factors in an opposite direction further comprises adjusting the weightings of the other factors equally in the opposite direction.

17. The method of claim 15, wherein effecting the weightings of the other factors in an opposite direction further comprises adjusting the weighting of each of the other factors in proportion to each factor's relative position to the other factors.

18. The method of claim 15, wherein effecting the weightings of the other factors in an opposite direction further comprises adjusting the weighting of each of the other factors in proportion to a position of the factor to a mid-point.

19. The method of claim 1, wherein generating the multiple factor sorted set of results further comprises a factor portion that contains a value for each inter-related factor for each search result.

20. An apparatus, comprising:
a computer system having a processor;
a multiple factor component hosted on the computer system that obtains two or more inter-related factors, sorts results using two or more inter-related factors into a multiple factor sorted set of results, wherein when one factor has its weight changed in a first direction, the other inter-related factors have their weight changed in a second opposite direction so that a total weighting of all of the other inter-related factors is constant and generates a multiple factor sorted set of results, the multiple factor sorted set of results listing each search result.

21. The apparatus of claim 20, wherein the multiple factor component receives an initial query that generates the plurality of results, the initial query having two or more search terms.

22. The apparatus of claim 20, wherein the multiple factor component receives a weighting for each factor using an interactive graphical element.

23. The apparatus of claim 22, wherein the interactive graphical element is a graphical representation that displays the multiple factors.

24. The apparatus of claim 23, wherein the interactive graphical element is a set of sliders.

25. The apparatus of claim 23, wherein the interactive graphical element is a chart.

26. The apparatus of claim 23, wherein the interactive graphical element is a pie chart.

27. The apparatus of claim 20, wherein the multiple factor component displays the multiple factor sorted set of results.

28. The method of claim 27 further comprising concurrent displays of the user interface and the multiple factor sorted set of results.

29. The method of claim 27 further comprising display of the user interface one of concurrently with and embedded within each search result.

30. The apparatus of claim 27, wherein the multiple inter-related factors further comprises a target value factor.

31. The apparatus of claim 30, wherein the multiple factor component displays an indication that a value for a particular factor has exceeded the target value.

32. The apparatus of claim 21, wherein each factor is one of the search terms from the initial query.

33. The apparatus of claim 20, wherein the multiple factor component selects the two or more inter-related factors from a list and receives a weighting for each selected factor.

34. The apparatus of claim 22, wherein the multiple factor component causes the adjustment of the weighting of at least one factor in a first direction and effects the weightings of the other factors in an opposite direction.

35. The apparatus of claim 34, wherein the multiple factor component effects the weightings of the other factors equally in the opposite direction.

36. The apparatus of claim 34, wherein the multiple factor component effects the weighting of each of the other factors in proportion to each factors relative position to the other factors.

37. The apparatus of claim 34, wherein the multiple factor component effects the weighting of each of the other factors in proportion to a position of the factor to a mid-point.

38. The apparatus of claim 02, wherein the multiple factor component generates a factor portion that contains a value for each inter-related factor for each search result.
